(19) United States
(12) Patent Application Publication
(10) Pub. No.: US 2011/0038276 A1
(43) Pub. Date: Feb. 17, 2011

(54) Relay Station, Radio Communication System, and Radio Communication Method

(75) Inventor: Takayasu Ninagawa, Gifu (JP)

Correspondence Address: PROCOPIO, CORY, HARGREAVES & SAVITCH LLP, 525 B STREET, SUITE 2200, SAN DIEGO, CA, 92101, US

(73) Assignee: KYOCERA CORPORATION, Kyoto (JP)

(21) Appl. No.: 12/989,267

(22) PCT Filed: Mar. 26, 2009
(86) PCT No.: PCT/JP2009/056169

§ 371 Date: Oct. 22, 2010

(30) Foreign Application Priority Data
Apr. 24, 2008 (JP) 2008-114689

(51) Int. Cl. H04L 12/26; H04W 36/00

(52) U.S. Cl. 370/252; 370/332

(57) ABSTRACT

Realizing the position of a wireless communication terminal and guaranteeing stable communication quality and realizing a seamless handover while maintaining wireless communication. A relay station 130 is provided with a position estimation part 350 which monitors communication quality with the wireless communication terminal and estimates a position of the wireless communication terminal, and a connection control part 352 which switches a QoS of communication quality with the wireless communication terminal and switches a handover reference according to the position of the wireless communication terminal.

### FIELD OF THE INVENTION

The present invention relates to a relay station which can relay communication between a wireless communication terminal and a base station, a wireless communication system and wireless communication method.

### BACKGROUND OF THE INVENTION

Recently, wireless communication terminals represented by PHS (Personal Handy Phone System) terminal or mobile phones are becoming widespread and telephone calls and information gathering regardless of place or time has become possible. In particular, in recent years, the amount of accessible information is continuously increasing and high speed and high quality wireless communication methods are being adopted in order to download large capacity data.

OFDM (Orthogonal Frequency Division Multiplexing) represented by IEEE802.11 or WIMAX can be exemplified as one of these high speed digital wireless communication methods. The OFDM method is categorized into one of the data multiplexing methods using multiple carrier waves of unit of time axis and the frequency range is effectively used by overlapping one part of the carrier wave bands so that the phase of a signal wave intersects between adjacent carrier waves. In addition, while in OFDM subchannels are allocated to each individual user by time division, in OFDMA (Orthogonal Frequency Division Multiplex Access) a plurality of users share all the subchannels and the most transmission efficient subchannel is allocated for each user.

In next generation high speed wireless communication methods such as WIMAX stated above, in the case of using a 2.5 GHz band or a higher frequency band, because the range where communication is possible (coverage) by one base stated is small in areas with poor signal strength such as places with many obstacles, it is necessary to arrange multiple base stations in order to cover the entire periphery. Furthermore, when an area with a small range where communication is possible by one base station is passed through by a movable body such as train or car for example, handover which switches the base station which becomes to point of connection occurs frequently leading to a drop in communication quality and increase in power consumption.

Therefore, a technology is disclosed wherein a relay station which relays between a base station and wireless communication terminal is fixed inside the movable body and communication power within the movable body is stabilized. However, this type of relay station is comprised of an amplifier or a filter and only includes a function for amplifying power while maintaining a signal wave form and is not provided with a communication control function. Therefore, no attention was paid to a decrease in communication quality of wasteful power consumption.

As a developed technology of this type of relay station, a technology is disclosed in which a relay station is provided within an aircraft and a wireless communication terminal is connected to the base station antenna which is connected to a ground communication network via the relay station. Here, it is possible to communicate with the ground communication network without using a satellite but using the passenger's terminal and it is possible to receive services such as internet communication or internet calls while in the aircraft.

### DISCLOSURE OF THE INVENTION

### Problems to be Solved by the Invention

However, in the relay station within the aircraft stated above, a wireless communication method between a wireless communication terminal and the relay station and a wireless communication method between a wireless communication terminal and the base station are different. Furthermore, it is necessary to additionally prepare a wireless communication method for a relay station for realizing wireless communication between a relay station and base station. Therefore, this leads to an increase in prior step processing burden and equipment costs for realizing wireless communication.

In addition, because it is necessary to disconnect communication when boarding and alighting an aircraft, it is presumed that connection with a base station or relay station in a wireless communication terminal is disconnected. As a result, no consideration is paid to the handover of a wireless communication terminal which switches the point of connection while maintaining a state of connection of communication.

It is possible to combine a wireless LAN which makes wireless communication possible in a small space such as a movable body, with a current wireless communication system and attach this function to a relay station. However, even in this case, because wireless communication in a wireless communication terminal is forced depending on the wireless communication method which is different between a usual base station and relay station, communication data before switching can not be used when this wireless communication method is switched and it is necessary to establish a new communication route each time.

In order to solve the above problems, it is an object of the present invention to provide a relay station, wireless communication system and wireless communication method which can obtain the position of a wireless communication terminal and secure stable communication quality and realize a seamless handover while maintaining wireless communication.

### Means for Solving the Problems

In order to solve the above stated problems, a representative structure of the present invention includes a relay station which can relay communication between a wireless communication terminal and a base station comprising: a monitoring part which monitors communication quality between the wireless communication terminal and the relay station in the case where the relay station relays communication between the wireless communication terminal and the base station; and a connection control part which controls the wireless communication terminal so that communication is performed between the wireless communication terminal and the base station without passing through the relay station according to a monitoring result. The relay station may be arranged in a movable body which can be boarded and alighted by a human, and may further comprise a position estimation part which estimates a position of the wireless communication terminal according to a monitoring result of said monitoring part.

Said position estimation part may determine that the wireless communication terminal exists inside the movable body when a value which shows communication quality is more than a predetermined value and when the communication quality is stable within a predetermined variable range.

Said connection control part may select a QoS with a high communication quality when the wireless communication terminal exists inside the movable body, and may select a QoS with high mobility when the wireless communication terminal exists outside the movable body.

Said connection control part may instruct the wireless communication terminal to refrain from handover when the wireless communication terminal exists inside the movable body, and may instruct the wireless communication terminal to perform handover to a base station other than the relay station when the wireless communication terminal exists outside the movable body.

Said connection control part may instruct the wireless communication terminal to perform handover to a base station with which the relay station performs wireless communication when the wireless communication terminal exists outside the movable body.

The relay station may further comprise: a terminal function part which functions as a wireless communication terminal with respect to the base station; and a base station function part which functions as a base station with respect to the wireless communication terminal.

Said terminal function part may perform wireless communication with the base station by a wireless communication method used between the base station and the wireless communication terminal.

Another representative structure of the present invention includes a wireless communication system comprising: a wireless communication terminal, a base station which performs wireless communication with said wireless communication terminal, and a relay station which relays communication between said wireless communication terminal and said base station; wherein said wireless communication terminal is provided with a terminal wireless communication part which establishes wireless communication with said base station or with said relay station, and a handover request part which requests a handover according to a handover reference from said relay station; said relay station is provided with a monitoring part which monitors the quality of communication between said wireless communication terminal and said relay station in the case where communication is relayed between said wireless communication terminal and said base station, a position estimation part which estimates a position of said wireless communication terminal according to a monitoring result of said monitoring part, and a connection control part which switches a QoS of wireless communication with said wireless communication terminal according to the estimated position of said wireless communication terminal; and said base station is provided with a base station wireless communication part which performs a handover between said relay station and said base station according to a handover request from said wireless communication terminal.

A further representative structure of the present invention includes a wireless communication method for performing wireless communication using a wireless communication terminal, a base station which performs wireless communication with the wireless communication terminal, and a relay station which can relay communication between the wireless communication terminal and the base station; wherein the wireless communication terminal establishes wireless communication with the relay station, the relay station monitors the communication quality of the wireless communication terminal and estimates a position of the wireless communication terminal, the relay station switches a QoS of wireless communication with the wireless communication terminal according to the position of the wireless communication terminal, and switches a handover reference of the wireless communication terminal, the wireless communication terminal performs a handover request to an indicated base station according to the handover reference from the relay station, and the base station performs the handover to a the base station from the relay station according to the handover request from the wireless communication terminal.

The structural elements and their explanation based on the technical concept of the relay station stated above can also be applied to the wireless communication system or wireless communication method.

### Effects of the Invention

As explained above, according to the present invention, it is possible to provide a relay station, wireless communication system and wireless communication method which can obtain the position of a wireless communication terminal and secure stable communication quality and realize a seamless handover while maintaining wireless communication.

### BRIEF EXPLANATION OF THE DRAWINGS

FIG. 1 is a block diagram which shows an exemplary structure of a wireless communication system.

FIG. 2 is a functional block diagram which shows the hardware structure of a PHS terminal.

FIG. 3 is a perspective diagram which shows the exterior appearance of a PHS terminal.

FIG. 4 is a block diagram which shows an exemplary structure of a base station.

FIG. 5 is a block diagram which shows an exemplary structure of a relay station.

FIG. 6 is an explanation diagram which shows a positional relationship when a PHS terminal exists inside a movable body.

FIG. 7 is an explanation diagram which shows a positional relationship when a PHS terminal is separated from a movable body.

FIG. 8 is an explanation diagram which shows an image of data transmission by a mobile IP.

FIG. 9 is an explanation diagram for explaining the registration process of a relay station.

FIG. 10 is an explanation diagram for explaining a handover process of a relay station.

FIG. 11 is an explanation diagram for explaining a wireless establishment process with a relay station in a PHS terminal.

FIG. 12 is an explanation diagram for explaining a separation process from a relay station in a PHS terminal.

### EXPLANATION OF REFERENCE SYMBOLS

110 PHS terminal (wireless communication terminal)
120 Base station
130 Relay station
160 Movable body
350 Position estimation part
352 Connection control part
354 Terminal function part
356 Base station function part
358 Position registration information control part
360 Channel information control part
362 Authentication information control part

### BEST EMBODIMENT FOR REALIZING THE INVENTION

The best embodiments for realizing the present invention will be explained in detail below with reference to the accompanying drawings. The dimensions, materials and other specific numerical values are simply for exemplifying easy understanding of the invention and do not limit the invention. In the present description and drawings, the structural elements which have essentially the same functional structure are indicated by the same reference numerals in order to omit overlapping explanations.

A wireless communication terminal represented by a PHS terminal or mobile phone constitutes a broadband wireless communication system with a plurality of base stations located at certain intervals and performs communication with other PHS terminals or servers on a communication network via this wireless communication system. Support of QoS and handover reference settings in a wireless communication system which includes this type of wireless communication terminal are explained in the present embodiment.

Here, in order to simplify understanding of the present embodiment, first, an exemplary structure of the wireless communication system is explained and then the specific operations of the wireless communication terminal is explained. In addition, here, a PHS terminal is used as an example of a wireless communication terminal, however, the present invention is not limited to this case. It is also possible to use various electronic devices which can perform wireless communication such as a mobile phone, note PC, PDA (Personal Digital Assistant), digital camera, music player, car navigation, portable TV, game console, DVD player, remote controller as the wireless communication terminal. In addition, the movable body indicates a vehicle which can be boarded and alighted such as a car, bus, train, boat or plane.

### [Wireless Communication System 100]

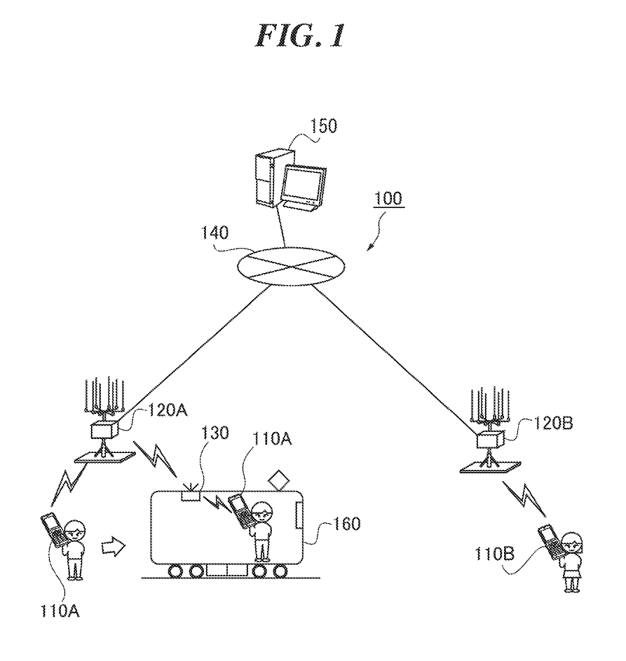

FIG. 1 is a block diagram which shows an exemplary diagram of a wireless communication system 100. The wireless communication system 100 is comprised of a PHS terminal 110 (110A, 110B), a base station 120 (120A, 120B), a relay station 130, an ISDN (Integrated Services Digital Network) line, the internet, a communication network 140 comprised of a dedicated line, and a relay server 150.

In the wireless communication system 100, when a user make a phone call from his or her own PHS terminal 110A to another PHS terminal 1108 via a communication channel, the PHS terminal 110A requests a wireless connection to the base station 120A which is located within a range where communication is possible. The base station 120A, which receives the wireless communication request, requests a communication connection with a desired communication partner to the relay server 150 via the communication network 140. Then the relay server 150 refers to the position registration information of the other PHS terminal 1108, selects the base station 120B which is within a wireless communication range of the other PHS terminal 1108, secures a communication route between the base station 120A and the base station 120B, and establishes communication between the PHS terminal 110A and the PHS terminal 110B.

Thereafter, if the user gets on a movable body 160 such as a train, the PHS terminal 110A does not connect directly with the base station 120A but is switched to an indirect communication via the relay station 130. The relay station 130 is fixed to the movable body 160 and moves with the movable body 160, and therefore it can make a communication possible inside the movable body. Because the relay station 130 and the PHS terminal 110A of the user inside the movable body move together without their positional relationship change, for example as long as an empty seat is not searched for, and because there is no obstacle between the relay station and the PHS terminal, it is possible to secure stable wireless communication. Therefore, it is possible to maintain communication between the PHS terminal 110A and the other PHS terminal 110B via the relay station 130 regardless of the movement of the movable body 160. Below, the PHS terminal 110, base station 120 and relay station 130 which are the structural elements of the wireless communication system 100 are individually explained.

### [PHS Terminal 110]

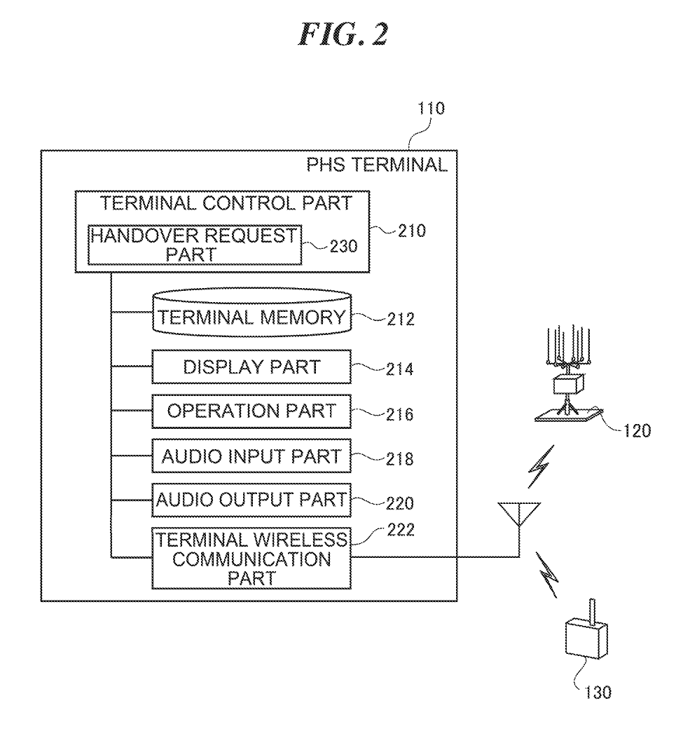

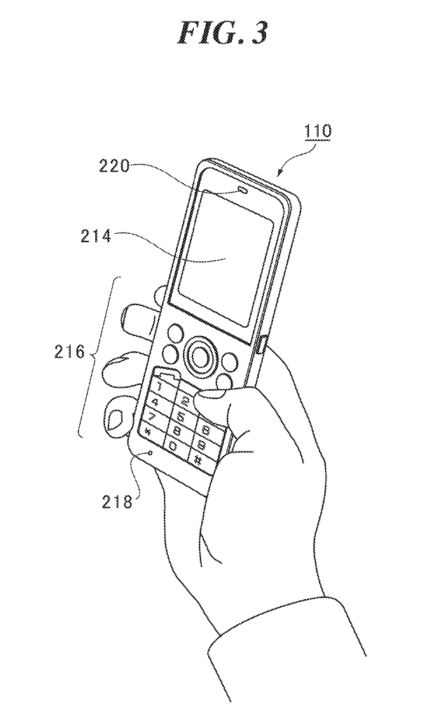

FIG. 2 is a function block diagram which shows the hardware structure of the PHS terminal 110, and FIG. 3 is a perspective diagram which shows the external appearance of the PHS terminal 110. The PHS terminal 110 is comprised of a terminal control part 210, a terminal memory 212, a display part 214, an operation part 216, an audio input part 218, an audio output part 220 and a terminal wireless communication part 222.

The terminal control part 210 maintains and controls the entire PHS terminal 110 using a semiconductor integrated circuit which includes a central processing unit (CPU). The terminal control part 210 also controls a call function, email sending and receiving function, camera function, music player function, and TV viewing function using a program in the terminal memory 212. In addition, the terminal control part 210 also functions as a handover request part 230 which requests a handover according to a handover reference from the relay station 130. Terminal memory 212 may be comprised of a ROM, RAM, EEPROM, non-volatile RAM, FLASH memory or HDD and stores programs processed by the terminal control part 210 or audio data.

The display part 214 may be comprised of a LCD or EL (Electro Luminescence) and can display a WEB browser or application GUI (Graphical User Interface) stored in the terminal memory 212 or presented from an application relay server (not shown in the diagram) via the communication network 140. The operation part 216 is comprised of switches such as keyboard, cross key or joystick and receives operation inputs from a user.

The audio input part 218 is comprised of an audio recognition means such as a microphone and a user's voice which is input when making a call is converted to an electrical signal which can be processed within the PHS terminal 110. The audio output part 220 is comprised of a speaker and converts the voice signal of the calling partner received by the PHS terminal 110 to audio and outputs the audio. In addition, the audio output part also outputs incoming call alert, operation sound of the operation part 216 and alarm.

The terminal wireless communication part 222 performs wireless communication with the base station 120 or relay station 130 via the communication network. Various wireless communication methods such as TMDS (Time Division Multiple Access), OFDM and OFDMA can be applied to the terminal wireless communication part 222.

### [Base Station 120]

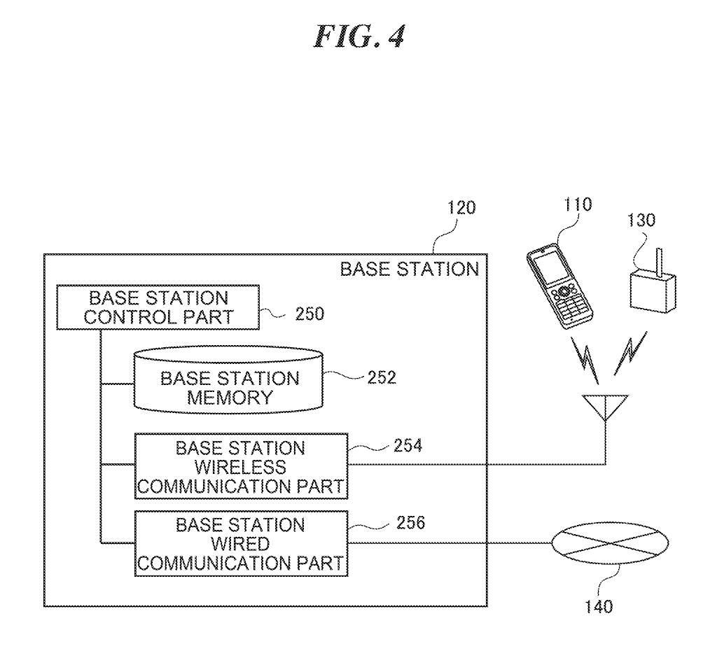

FIG. 4 is a block diagram which shows an exemplary structure of the base station 120. The base station 120 is comprised of a base station control part 250, a base station memory 252, a base station wireless communication part 254 and a base station wired communication part 256.

The base station control part 250 maintains and controls the entire base station 120 using a semiconductor integrated circuit which includes a central processing unit (CPU). The base station memory may be comprised of a ROM, RAM, EEPROM, non-volatile RAM, FLASH memory or HDD and stores programs processed by the base station control part 250.

The base station wireless communication part 254 establishes wireless communication with the PHS terminal 110 or the relay station 130 by OFDMA for example, and can adaptively change the modulation means according to the communication state of the PHS terminal 110 or the relay station 130 (Adaptive Modulation). In addition, the base station wireless communication part 254 performs a handover between the relay station 130 and the base station according to a handover request from the PHS terminal 110. The base station wired communication part 256 can connect with a variety of servers which includes the relay server 150 via the communication network 140.

### [Relay Station 130]

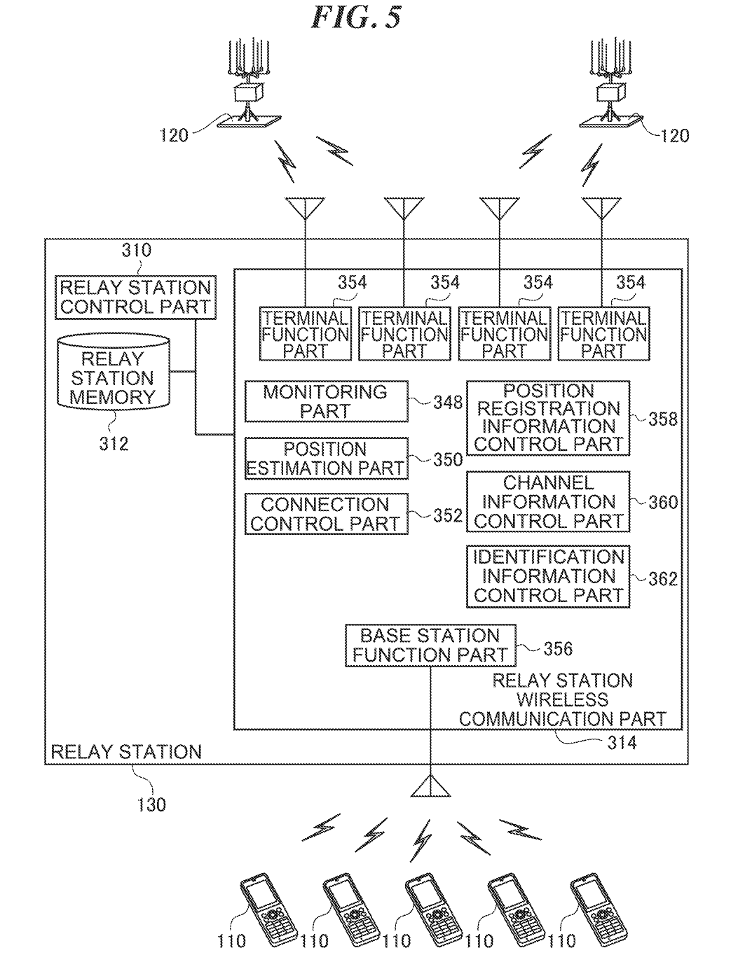

FIG. 5 is a block diagram which shows an exemplary structure of the relay station 130. The relay station is comprised of a relay station control part 310, a relay station memory 312 and a relay station wireless communication part 314.

The relay station control part 310 maintains and controls the entire relay station 130 using a semiconductor integrated circuit which includes a central processing unit (CPU). The relay station memory 312 may be comprised of a ROM, RAM, EEPROM, non-volatile RAM, FLASH memory or HDD and stores programs processed by the relay station control part 310. The relay station wireless communication part 314 connects to the PHS terminal 110 and the base station 120 and relays between the PHS terminal 110 and the base station 120. In addition, the relay station wireless communication part 314 also functions as a monitoring part 348, a position estimation part 350, a connection control part 352, a terminal function part 354, a position registration information control part 358, a channel information control part 360, and an identification information control part 362.

The monitoring part 348 monitors the quality of communication with the PHS terminal 110 when the relay station 130 communicates with the PHS terminal 110.

The position estimation part 350 estimates the position of the PHS terminal 110 exists, particularly inside or outside a movable body according to a monitoring result of the monitoring part 348. Here, the quality of communication indicates electrical field strength, SNR (Signal Noise Ratio) and BER (Bit Error Rate).

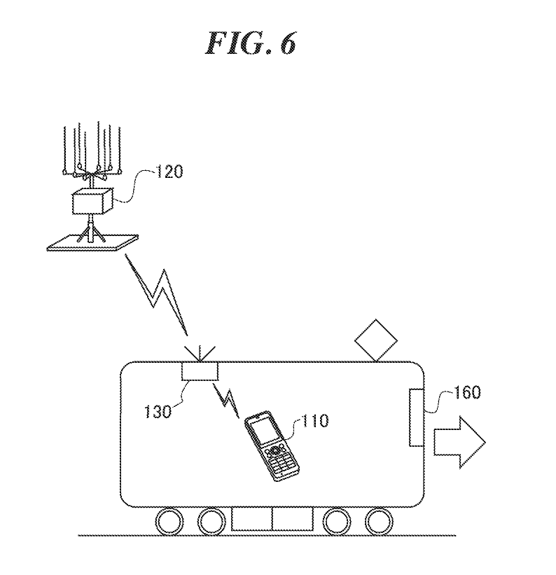

FIG. 6 is an explanation diagram which shows a positional relationship when the PHS terminal 110 exists inside a movable body. The position estimation part 350 usually transmits (broadcasts) a weak quantitative signal within the movable body, and the PHS terminal 110 measures the radio strength of this quantitative signal transmitted from the relay station 130 via a radio field strength measurement instruction by a report request command etc. from the relay station 130, and returns it to the relay station 130 as radio strength information.

The position estimation part 350 determines that the PHS terminal 110 exists inside a movable body in the case when the radio strength information from the PHS terminal 110 exceeds a certain amount and is stable within a certain variable range. The movable body 160 is often covered by metal which blocks a signal and therefore communication quality is significantly different between the inside and the outside of the movable body. In addition, because distance or space between the PHS terminal 110 and the relay station 130 does not change within the movable body, low power is enough to maintain stable communication. Therefore, the position estimation part 350 can estimate that the PHS terminal 110 exists inside the movable body by high and stable communication quality.

The position estimation part 350 estimates distance by measuring the radio strength of a quantitative signal. However, a distance can be estimated by other methods. If it is possible to know the transmitting power of the PHS terminal 110, a deterioration in power is derived from the transmitting power and radio strength of the reception signal in order to estimate a distance, or transmission delay of radio signal path to the PHS terminal 110 is measured in order to estimate a distance.

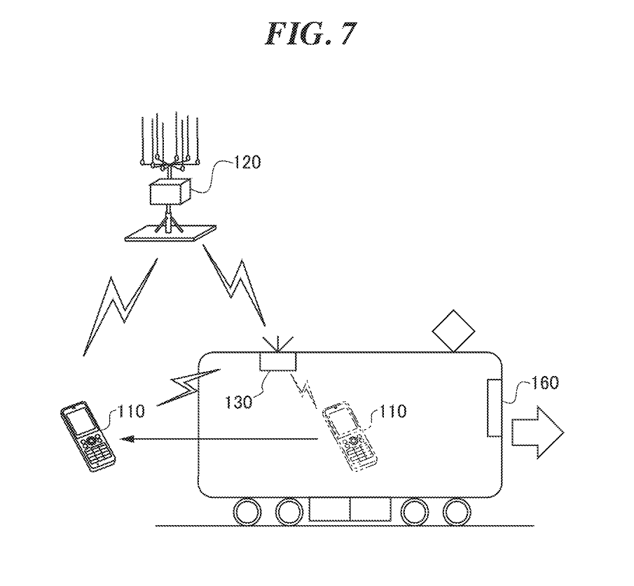

FIG. 7 is an explanation diagram which shows the positional relationship when the PHS terminal 110 is outside a movable body. When a user of the PHS terminal 110 moves to the outside of a movable body, because metal which covers the movable body 160 becomes an obstacle which obstructs radio signals, wireless quality significantly deteriorates. In addition, after leaving the movable body, because the distance between the relay station 130 and the PHS terminal 110 becomes larger when the movable body 160 moves further away as is shown by the white arrow, the wireless quality deteriorates further. Therefore, a value which shows communication quality is lower than a predetermined value or the communication quality deviates outside a predetermined variable range and the position estimation part 350 determines that the PHS terminal 110 exists outside the movable body.

In addition, because the position estimation part 350 not only determines the inside and outside of a movable body but also tells the switching timing between the inside and outside of a movable body, the connection control part 352 described later can give instructions to perform handover to the PHS 110 before it becomes too distant and difficult to perform a handover between the PHS terminal 110 and relay station 130. According to this structure, it is possible to avoid a situation wherein it is necessary to reset the position of the PHS terminal 110 from the initial settings because communication is terminated by the movement of the movable body 160 before handover is performed. In this way, it is possible to realize a seamless handover while maintaining wireless communication.

The connection control part 352 switches QoS of the wireless communication of the PHS terminal 110 according to the position of the PHS terminal 110 and switches the handover reference of the PHS terminal 110.

With regards to QoS, while the position estimation part 350 estimates that the PHS terminal 110 exists inside a movable body, the connection control part 352 selects QoS with a high communication quality as a wireless communication with the PHS terminal 110, and when the position estimation part 350 estimates that the PHS terminal 110 exists outside a movable body, the connection control part 352 selects QoS with a high mobility. Here, QoS indicates overall quality of a service which includes communication speed, modulation method and output power and it may be adjusted according to the communication quality.

For example, as described above, because there is no obstacle which obstructs wireless communication within the movable body and because there is almost no change in the distance between the relay station 130 and PHS terminal 110 within a small space such as the movable body 160, the communication environment is very good. Therefore, as is shown in FIG. 6, when the PHS terminal exists inside the movable body it is possible to select a QoS with a high communication quality and reduce power consumption. In addition, because communication quality is not guaranteed when the PHS terminal 110 moves to the outside of the movable body as is shown in FIG. 7, the connection control part 352 must cancel a reduction in power consumption while selecting a QoS with high mobility.

In addition, with regard to a handover reference, the connection control part 352 gives instructions to refrain from handover when the PHS terminal 110 exists inside a movable body and gives instructions to perform a handover to a base station 120 other than the relay station when the PHS terminal 110 exists outside the movable body. In a conventional wireless communication system a request for a handover is limitedly issued from the PHS terminal 110, however, in next generation high speed wireless communication methods such as WIMAX, a request for handover can be issued in both directions. Therefore, it is possible to request a handover from the connection control part 352 to the PHS terminal 110.

Because a good communication environment is achieved with the relay station 130 inside the movable body as described above, a handover should not be performed recklessly even if a base station 120 with good communication quality temporarily exists. In addition, wireless communication with a relay station 130 where there is a high possibility of increasing distance should not be endlessly maintained outside the movable body. Therefore, when the PHS terminal 110 exists inside the movable body as is shown in FIG. 6, the handover is prevented for example by increasing the threshold of the handover. In addition, when the PHS terminal 110 exists outside the movable body as is shown in FIG. 7, a threshold of the handover is decreased and wireless communication shifts to a base station 120 other than the relay station 130.

The connection control part 352 not only gives instructions to perform a handover to a base station 120 other than the relay station when the PHS terminal 110 exists outside the movable body but may also give instructions to perform a handover to the base station 120 in which the relay station performs wireless communication.

The relay station 130 selects an arbitrary base station 120 as the most appropriate wireless communication destination. Therefore, there is a high possibility that the optimum wireless communication destination for the PHS terminal 110 which existed near the relay station 130 is the base station 120 which performs wireless communication with the relay station 130. The relay station 130 offers information of this base station 120 which has good wireless communication with the relay station thereby the PHS terminal 110 can quickly establish wireless communication with the base station 120.

Furthermore, the connection control part 352 can appropriately change the modulation method according to the communication state with the PHS terminal 110 (adaptive modulation).

As explained above, the position estimation part 350 knows the position of the PHS terminal 110, in particular whether the PHS terminal 110 is inside or outside a movable body and the connection control part 352 presents an appropriate communication state to the PHS terminal 110 according to this position. In this way, by presenting an appropriate communication state to the PHS terminal 110 it is possible to establish stable QoS even within the movable body, and it is also possible to realize seamless handover while maintaining wireless communication by a switched appropriate QoS even outside the movable body.

The terminal function part 354 functions as a PHS terminal 110 in relation to the base station 120. The relay station 130 is provided for example with four terminal function parts 354 as is shown in FIG. 5, and each connects independently with the base station 120. The four terminal function parts 354 can connect with one base station 120 and each can respectively connect with a plurality of base stations 120. For example, the four terminal function parts 354 can accommodate ten times larger number of i.e. forty PHS terminals 110. This is because the communication of a plurality of PHS terminals 110 can be divided into a time direction and band direction and accepted with the resource of one terminal function part 354. Therefore, the wireless communication system 100 can be applied to audio communication via data communication or VoIP (Voice over Internet Protocol) and of course audio communication which requires real time communication.

The handovers of each of the plurality of terminal function parts 354 are switched in sequence without overlapping the timings of each handover even when handovers of the relay station 130 to a base station 120 occur as described below. Therefore, even if wireless communication is interrupted at the point when one terminal function part 354 is switched, because the wireless communication between the other terminal function parts 354 and base station 120 is not interrupted, it is possible to maintain communication between the PHS terminal 110 and the base station 120 and perform a seamless handover.

In addition, the terminal function part 354 performs wireless communication with the base station 120 using a wireless communication method, here WIMAX, which is used between the base station 120 and the PHS terminal 110. WIMAX is comprised by a MAC physical layer specialized for use in a relay station within a standard range.

According to the above structure, it is not necessary to newly prepare a wireless communication method between the relay station 130 and the base station 120 and it is possible to reduce process burden and installation costs of the PHS terminal 110. In addition, because the terminal function part 354 of the relay station 130 is placed in the same situation as the PHS terminal 110 inside the movable body, the terminal function part 354 can estimate, in place of the PHS terminal 110, communication quality and it is possible to transmit this information to the PHS terminal 110.

The base station function part 356 functions as a base station in relation to the PHS terminal 110. Basically one base station function part 356 is arranged as is shown in FIG. 5, and performs communication with all PHS terminals 110 inside a movable body. In addition, it is possible to arrange a plurality of base station function parts 356 in the case where they are used in a relatively wide space such as a boat or plane. With this base station function part 356, although one or a plurality of PHS terminals 110 inside the movable body are actually connected with the relay station 130, they can maintain communication as though they are connected to the base station 120.

The position registration information control part 358 manages the MAC address, IP address and position registration information of the PHS terminal 110 which is connected to the base station function part 356. In addition, in the present embodiment, even if the connection destination with the PHS terminal 110 is either the base station 120 or the relay station 130, the position registration information control part 358 functions as a foreign agent of a mobile IP so that the wireless communication method from the PHS terminal 110 becomes equal.

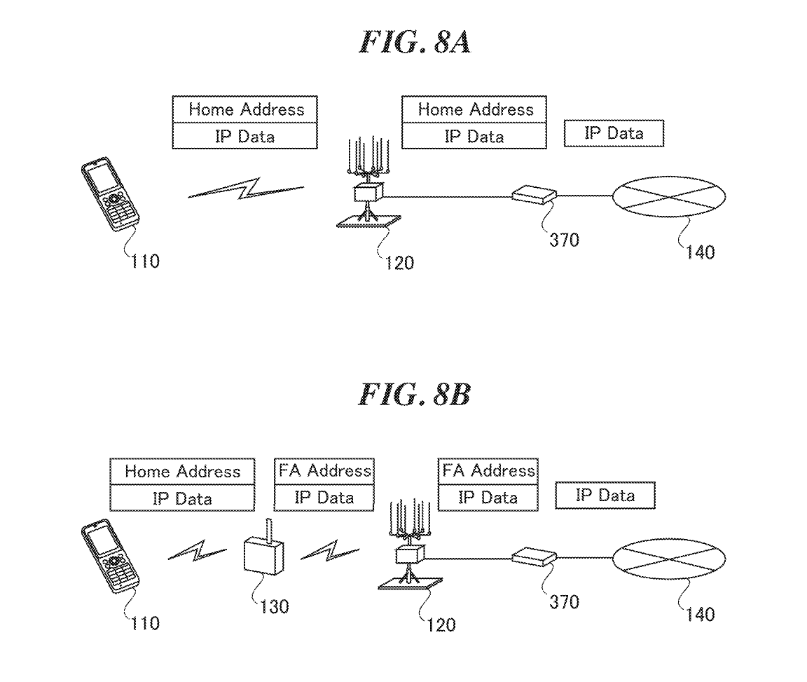

FIG. 8 is an explanation diagram which shows an image of data transmission by a mobile IP. In FIG. 8A, the PHS terminal 110 performs direct communication with the base station 120. Here, the PHS terminal 110 transmits IP data which is capsulized by the mobile IP to the home agent 370. In FIG. 8B, the PHS terminal 110 is connected to the base station 110 via the relay station 130. Here, the PHS terminal 110 performs a similar kind of transmission as FIG. 8A to the relay station 130, however, an FA address which specifies a foreign agent is used between the relay station 130 and the base station 120. Therefore, a capsulized FA address and IP address are transmitted between the relay station 130 and the base station 120 and between the base station 120 and the home agent 370. The position registration information control part 358 also manages this type of relay station 130 FA address.

In addition, because it is assumed that the relay station 130 also moves the same as the PHS terminal 110 with respect to a relay server 150, the position of the relay station 130 is also registered in the relay server 150. Therefore, the position of the PHS terminal 110 which is connected with the base station 120 via the relay station 130 is registered as a terminal lower than the relay station 130 with respect to this base station 120.

The channel information control part 360 controls the QoS between the PHS terminal 110 and the base station function part 356 according to the quality of communication between them and also controls the QoS between the terminal function part 354 and the base station 120 so that the QoS between the PHS terminal 110 and the base station function part 356 can be maintained.

The authentication information control part 362 functions as an authentication (AAA), authorization and accounting server with respect to the base station function part 356 and transmits authentication information to the PHS terminal 110.

### [Wireless Communication Method]

Next, a wireless communication method which performs wireless communication between the PHS terminal 110, base station 120 and relay station 140 is explained in detail. Here, an explanation of the operation of the relay station 130 is divided into (operation 1) registration of the relay station 130, (operation 2) handover of the relay station 130, (operation 3) establishment of wireless communication with the relay station in the PHS terminal 110 and (operation 4) separation from the relay station 130 in the PHS terminal 110.

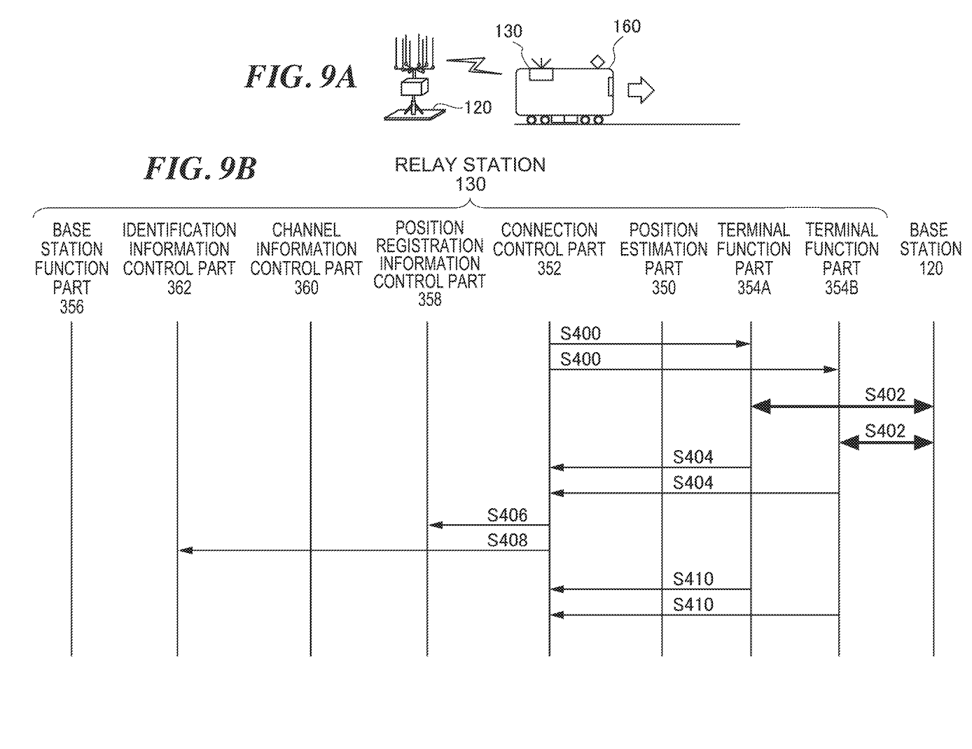

FIG. 9 is an explanation diagram for explaining the registration process of the relay station 130 (operation 1). In particular, FIG. 9A shows a sequence diagram which shows the positional relationship between the relay station 130 and the base station 120, and FIG. 9B is a sequence diagram which shows the registration process of the relay station 130.

First, the connection control part 352 of the relay station 130 requests activation of each terminal function part 354 (354A, 354B) within the relay station (step S400), each terminal function part 354A, 254B senses a carrier, and establishes wireless communication independently from the base station 120 which has a high communication quality (step S402).

When wireless communication is established between each terminal function part 354A, 354B and the base station 120, a completion notification is sent to the connection control part 352 (step S404). The connection control part 352 transmits a MAC address, IP address and base station process capability included in the completion notification to the position registration information control part 358 (step S406) and transmits an authentication key and a validity date of the authentication key to the authentication information control part 362 (step S408). This type of connection information is periodically notified to the connection control part 352 from each terminal function part 354 (step S410) and a handover of the relay station 130 is performed according to the details within the notification.

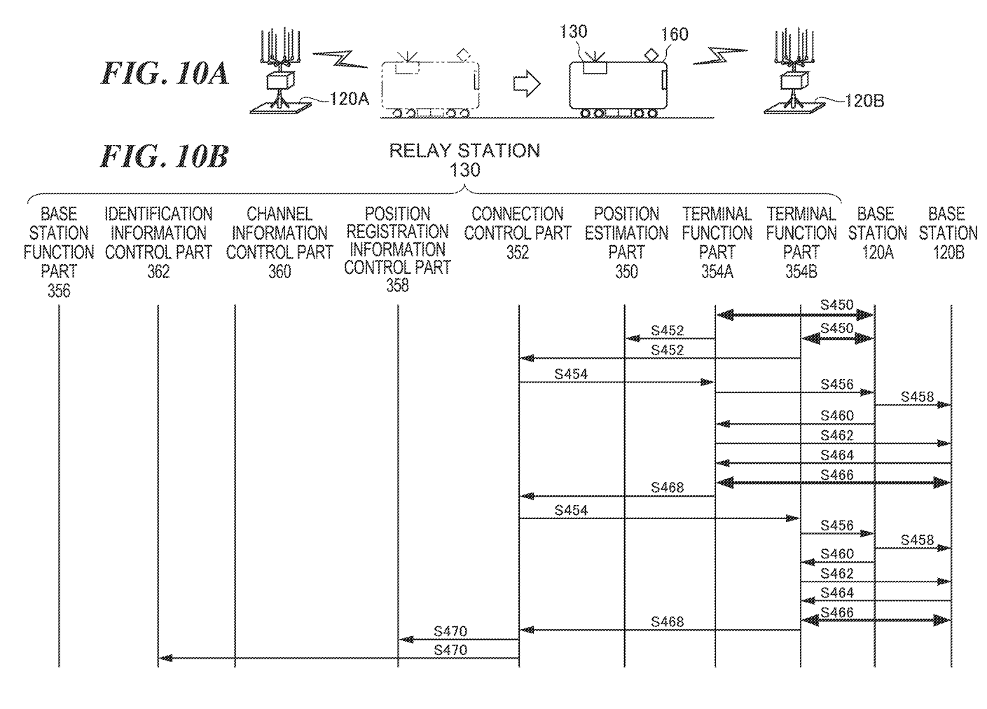

FIG. 10 is an explanation diagram for explaining the handover process of the relay station 130 (operation 2). In particular, FIG. 10A shows a sequence diagram which shows the positional relationship between the relay station 130 and the base station 120, and FIG. 10B shows a sequence diagram which shows the handover process of the relay station 130.

The relay station 130 performs communication with the base station 120A via the terminal function parts 354A, 354B (step S450). The connection control part 352 receives periodic connection information from the terminal function part 354 (step S452), and when maintaining current communication with the base station 120A becomes difficult due to movement of the relay station 130, the connection control part 352 attempts a handover to another base station 120B. At the time of this handover, the terminal function parts 354A, 354B are not switched at the same time but switched in sequence while adjusting the timing.

First, the connection control part 352 gives instructions to perform a handover to only the terminal function part 354A among the two terminal function parts 354A, 354B which are connected to the base station 120A (step S454) and the terminal function part 354A requests a handover to the base station 120A (step S456).

The base station 120A which receives the handover request notifies the base station 120B of the switching destination of the terminal information via the relay server 150 (step S458) and returns a handover reply to the terminal function part 354A (step S460). Then, the terminal function part 354A requests a connection to the base station 120B which is a new connection destination (step S462) and establishes (step S466) a communication connection between the terminal function part 354A and the base station 120B using the connection reply (step S464). The terminal function part 354A transmits that the handover is completed to the connection control part 352 (step S468).

When the handover of the terminal function part 354A is completed the connection control part 352 next requests a handover to the terminal function part 354B. Because the operation of this handover is essentially the same as the process of the terminal function part 354A (step S454-S468) except when object of the handover is the terminal function part 354B, an explanation is omitted here.

When the handover over the terminal function part 354A and 354B is completed the connection control part 352 transmits connection information of that time to the position registration information control part 358 and the authentication information control part 362 (step S470).

As described above, with respect to the handover of the relay station 130 in the present embodiment, all the terminal function parts 354 perform handover not simultaneously but one by one by shifting the timing of each handover, therefore stable wireless communication is possible without a break in communication of the entire relay station 130.

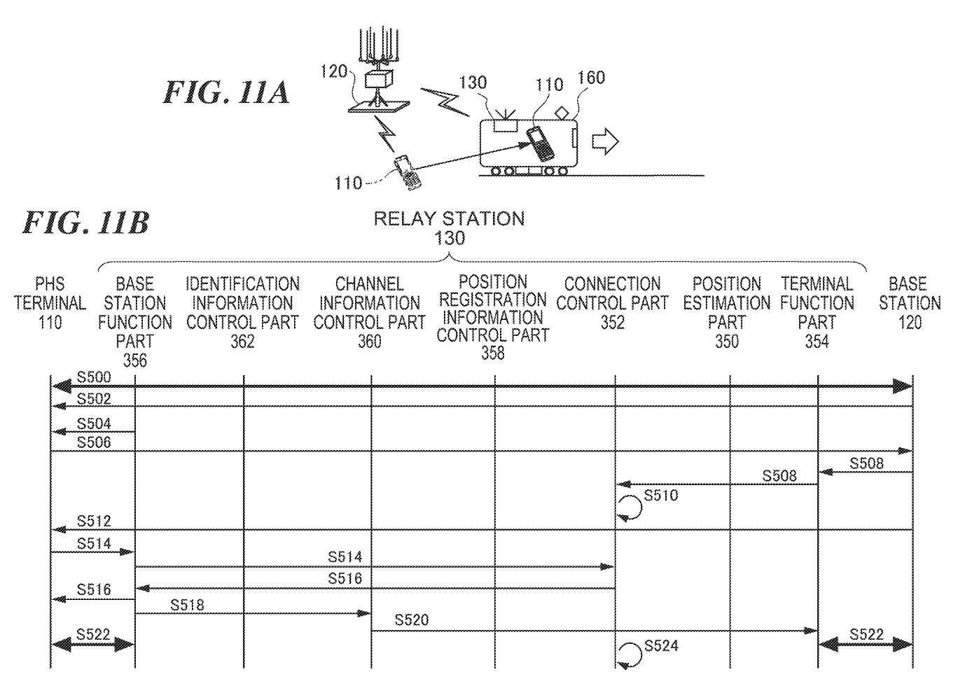

FIG. 11 is an explanation diagram for explaining a process for establishing wireless communication with the relay station 130 in the PHS terminal 110 (operation 3). In particular, FIG. 11A shows a sequence diagram which shows the positional relationship between the relay station 130, the base station 120 and the PHS terminal 110, and FIG. 11B shows a sequence diagram which shows the process for establishing wireless communication with the relay station 130 in the PHS terminal 110.

The PHS terminal 110 establishes wireless communication with the base station 120 (step S500). At this time, the base station 120 informs the PHS terminal 110 as the base station 120 which is adjacent to the base station function part 356 of the relay station belonging to the base station (step S502). The PHS terminal 110 obtains the notification information sent from the base station function part 356 based on this information and prepares a handover (step S504). The PHS terminal 110 can achieve handover timing by the adjacent information from the base station 120 and a smooth handover to the inside of the movable body is possible.

The PHS terminal 110 performs a carrier sense via the relay station 130 using the notification information from the base station function part 356, and requests a handover with respect to the base station 120 if the electrical field strength from the base station function part 356 is more than a predetermined value (step S506). At this time, because communication takes place in a limited space such as a movable body, the relay station 130 can set the predetermined value to a value higher than the threshold with respect to a normal base station 120.

The base station 120 receives a handover request from the PHS terminal 110, gives instructions to perform handover to the relay server 150, and when confirmation from the relay server 150 is received, the handover request is transmitted to the connection control part 352 via the terminal function part 354 of the relay station 130 (step S508). Then, the connection control part 352 waits for the connection request from the PHS terminal 110 to arrive at the base station function part 356 (step S510).

In answer to the handover reply from the base station 120 (step S512) the PHS terminal 110 requests connection to the connection control part 352 via the base station function part 356 of the relay station 130 (step S514), and the connection control part 352 performs a preparation completion reply with respect to the PHS terminal 110 (step S516). In answer to the preparation completion reply, the base station function part 356 performs a channel secure request (step S518) to the channel information control part 360, and the channel information control part 360 secures a channel in the terminal function part 354 (step S520). In this way, wireless communication is established between the PHS terminal 110 and the relay station 130 and between the relay station 130 and the base station 120 (step S522), and wireless communication becomes possible for the PHS terminal the same as a usual base station 120.

In addition, when it is confirmed that the PHS terminal 110 exists inside the movable body by the position estimation part 350, the connection control part 352 selects a QoS with a high communication quality. In this way, power consumption can be reduced, the threshold of the handover of the PHS terminal 110 is increased and handover is refrained (step S524).

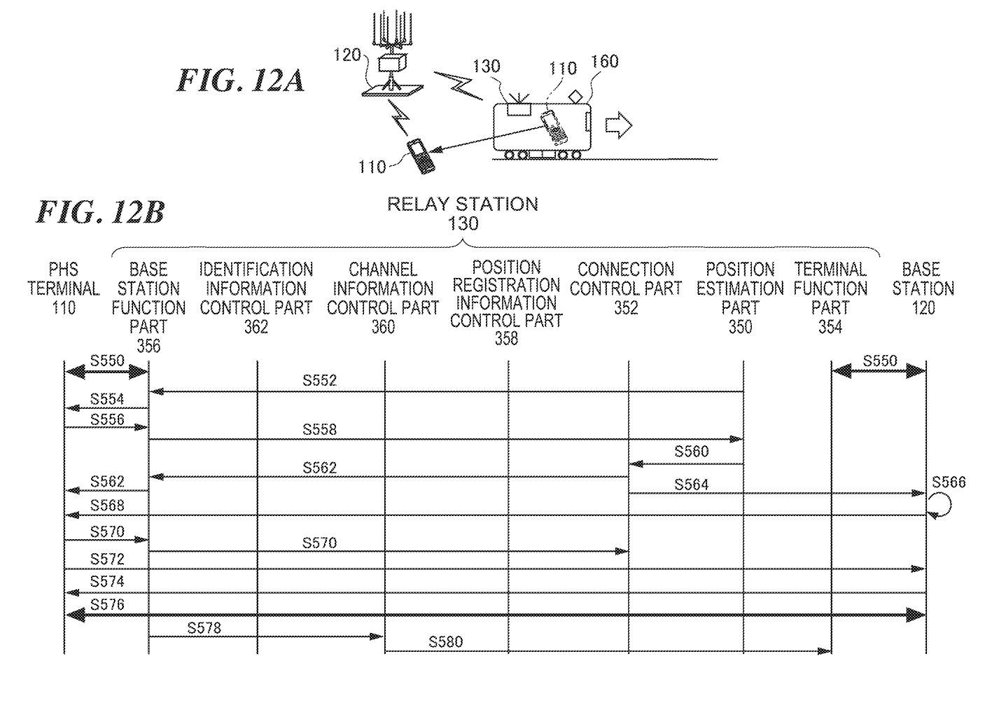

FIG. 12 is an explanation diagram which explains a separation process from a relay station in the PHS terminal (operation 4). In particular, FIG. 12A shows a sequence diagram which shows the positional relationship between the relay station 130, the base station 120 and the PHS terminal 110, and FIG. 12B shows a sequence diagram which shows the separation process from a relay station in the PHS terminal.

The PHS terminal 110 establishes wireless communication with the relay station 130 and the relay station establishes wireless communication with the base station 120 (step S550). At this time, the position estimation part 350 transmits a weak quantitative signal to the base station function part 356 (step S552). The PHS terminal 110 measures the signal strength of the quantitative signal sent form the relay station 130 at predetermined time intervals (step S554), and replies to the relay station as signal strength information (step S556). This signal strength information is analyzed by the position estimation part 350 (step S558).

Here, in the case where position estimation part 350 determines that the signal strength shown by the signal strength information is below a predetermined value or deviates from a predetermined variable range, it is assumed that the signal strength has been significantly deteriorated. That is, it is assumed that the PHS terminal 110 has separated from the movable body 160. In addition, this information is transmitted to the connection control part 352 (step S560). The connection control part 352 requests a handover via the base station function part 356 to the PHS terminal 110 (step S562). At this time, in the handover request, a handover to the base station 120 in which the relay station establishes wireless communication is encouraged, a QoS with high mobility is selected and power consumption is returned to normal. Here, when a handover is requested, a handover to the base station 120 in which the relay station establishes wireless communication is encouraged. However, it is also possible to request so that other base stations are selected and it is also possible to ask the PHS terminal 110 to select a base station as a handover destination.

In addition, the handover reference which the relay station requests to the PHS terminal 100 may be different from the handover reference which the base station 120 requests to the PHS terminal 110. Furthermore, the handover reference for when the PHS terminal 110 performs handover from the base station 120 to another base station may be different from the handover reference when the PHS terminal 110 performs handover from the base station 120 to the relay station 130.

In addition, the connection control part 352 concurrently transmits information of the PHS terminal 110 which is necessary for handover to the base station 120 (step S564). The base station 120 receives a handover request from the relay station 130, gives instructions to perform a handover to the relay server 150, obtains confirmation from the relay server 150 and a state of waiting for a connection request from the PHS terminal 110 is reached (step S566).

The PHS terminal 110 obtains notification information sent from the base station 120 (step S568) and prepares a handover. The PHS terminal 110 performs a carrier sense to the base station 110 via this notification information and if the electrical field strength from the base station 120 is more than a predetermined value, the base station 120 remains as the handover destination and a handover replay is returned to the relay station 130 (step S570).

The PHS terminal 110 transmits a connection request to the base station 120 (step S572). The base station 120 receives the connection request from the PHS terminal 110 and returns a connection reply to the PHS terminal 110 (step S574). In this way, wireless communication is established between the PHS terminal 110 and the base station 120. The base station function part 356 performs a channel release request to the channel information control part 360 according to the handover reply (step S578) and the channel information control part 360 releases a channel in the terminal function part 354 (step S580).

Even in this wireless communication method, as well as being able to realize the position of the PHS terminal 110 and guarantee stable communication quality, it is also possible to realize seamless handover while maintaining wireless communication.

That is, a representative structure of the relay station 130 in the present embodiment is a relays station 130 which can relay communication between the PHS terminal 110 and the base station 120, wherein a monitoring part 348 which monitors the quality of communication between the PHS terminal 110 and the relay station, and a connection control part 352 which controls the PHS terminal 110 so that communication between the PHS terminal 110 and the base station 120 is performed without passing through the relay station according to the monitoring result, are arranged. This relay station 130 is arranged in a movable body 160 which can be boarded and alighted by a user and a position estimation part 350 which estimates the position of the PHS terminal 110 according to the monitoring result of the monitoring part 348 may also be arranged.

With the structure described above, the position estimation part 350 realizes the position of the PHS terminal 110, in particular whether the PHS terminal 110 is inside or outside of the movable body 160, and the connection control part 352 provides a communication state appropriate for the PHS terminal 110 according to this position. In this way, it is possible to secure a stable QoS (Quality of Service) even if the PHS terminal remains inside the movable body 160 by providing a communication state appropriate to the PHS terminal 110, and it is possible to realize a seamless handover while maintaining wireless communication with a switched appropriate QoS even if the PHS terminal is separated from the movable body 160.

The position estimation part 350 can determine whether the PHS terminal 110 is inside the movable body 160 when the a value which shows communication quality is more than a predetermined value and when communication quality is stable within a predetermined variable range.

In the case where the PHS terminal 110 moves from the inside of the movable body 160 to the outside of the movable body 160, because metal which covers the movable body 160 becomes obstacle which obstructs a signal, wireless communication quality significantly deteriorates. In addition, after leaving the movable body 160, because the distance between the relay station 130 and the PHS terminal 110 increases when the movable body 160 moves further away, communication quality further deteriorates. Therefore, it is possible to determine that the PHS terminal 110 is inside the movable body 160 when a value which shows communication quality is more than a predetermined value and communication quality is stable within a predetermined variable range, and it is possible to determine that PHS terminal 110 is outside of the movable body 160 in all other states. In addition, because the position estimation part 350 not only distinguishes between inside and outside of the movable body 160 but can also distinguish the point in time when a switch between inside and outside occurs, it is possible to speed up the handover to the PHS 110 before it becomes too difficult to perform a handover between the PHS terminal 110 and relay station 130, and it is possible to realize with certainty a seamless handover while maintaining wireless communication.

The connection control part 352 may select a QoS with a high level of communication quality when the PHS terminal 110 exists inside the movable body 160 and may select a QoS with a high level of mobility when the PHS terminal 110 exists outside of the movable body 160.

The communication environment is very good because there is no obstacle which prevents wireless communication within the movable body 160 and because there is almost no change in the distance between the relay station 130 and the PHS terminal in the small space of the movable body 160. Therefore, in the case where the PHS terminal 110 exists inside the movable body 110 it is possible to select a QoS with a high level of communication quality and reduce power consumption. Because communication quality is not guaranteed outside the movable body 160, a reduction in power consumption must be cancelled when selecting a QoS with a high level of mobility.

The connection control part 352 may give instructions to refrain from a handover when the PHS terminal exists inside the movable body 160 and may give instructions to perform a handover to the base station 120 other than the relay station when the PHS terminal 110 exists outside of the movable body 160.

Because a good communication environment is formed with the relay station 130 inside the movable body 160 as described above, a handover should not be performed recklessly even if a base station 120 with good communication quality temporarily exists. In addition, wireless communication with a relay station 130 where there is a high possibility of increasing distance should not be endlessly maintained outside the movable body 160. Therefore, when the PHS terminal 110 exists inside the movable body 160, the handover is reduced by a device which can increase the threshold of the handover, and when the PHS terminal 110 exists outside of the movable body 160, a threshold of the handover is decreased and wireless communication shifts to a base station 120 other than the relay station 130.

The connection control part 352 may also give instructions to perform a handover to the base station 120 in which the relay station performs wireless communication when the PHS terminal 110 exists outside of the movable body 160.

The relay station 130 selects an arbitrary base station 120 as the most appropriate wireless communication destination. Therefore, there is a high possibility that the optimum wireless communication destination for the PHS terminal 110 which existed near the relay station 130 is the base station 120 which performs wireless communication with the relay station 130. The relay station 130 offers information of this base station 120 which has good wireless communication with the relay station thereby the PHS terminal 110 can quickly establish wireless communication with the base station 120.

This relay station 130 may be further provided with a terminal function part 354 which functions as the PHS terminal 110 with respect to the base station 110, and a base station function part 356 which functions as the base station 120 with respect to the PHS terminal 110.

According to this structure, the relay station 130 functions as the PHS terminal 110 when connected with the base station 120 and it is possible to treat the relay station 130 the same as the PHS terminal 110.

The terminal function part 354 may perform wireless communication with the base station 120 by the wireless communication method used between the base station 120 and the PHS terminal 110.

With this structure, it is no longer necessary to prepare a new wireless communication method between the relay station 130 and the base station 120, and it is possible to reduce the process burden and installation costs of the PHS terminal 110. In addition, because the terminal function part 354 of the relay station 130 is placed in the same situation as the PHS terminal 110 inside the movable body 160, instead of the PHS terminal 110, communication quality is estimated and it is possible to transmit this information to the PHS terminal 110.

In addition, another representative structure of the present embodiment is a wireless communication system provided with a PHS terminal 110, a base station 120 which performs wireless communication with the PHS terminal 110, and a relay station 130 which can relay communication between the PHS terminal 110 and the base station 130, wherein the PHS terminal 110 is provided with a terminal wireless communication part 222 which establishes wireless communication with the base station 120 or the relay station 130, and a handover request part 230 which requests a handover according to a handover reference from the relay station 130, the relay station 130, in the case where communication is relayed between the PHS terminal 110 and the base station 120, is provided with a monitoring part 348 which monitors the quality of communication between the PHS terminal 110 and the relay station, a position estimation part 350 which estimates the position of the PHS terminal 110 according to the monitoring result of the monitoring part 348, and a connection control part 352 which switches a QoS of wireless communication with the PHS terminal 110 according to the position of the PHS terminal 110, and switches the handover reference of the PHS terminal 110, and the base station 120 is provided with a base station wireless communication part 254 which performs a handover between the relay station 130 and the base station according to a handover request from the PHS terminal 110.

In addition, another representative structure of the present embodiment is a wireless communication method which performs wireless communication using a PHS terminal 110, a base station 120 which performs wireless communication with the PHS terminal 110, and a relay station 130 which can relay communication between the PHS terminal 110 and the base station 130, wherein the PHS terminal 110 establishes wireless communication with the relay station 130, the relay station 130 monitors the communication quality of the PHS terminal 110 and estimates the position of the PHS terminal 110, switches a QoS of wireless communication with the PHS terminal 110 according to the position of the PHS terminal 110, and switches a handover reference of the PHS terminal 110, the PHS terminal 110 performs a handover request to an indicated base station 120 according to the handover reference from the relay station 130, and the base station 120 performs the handover to the base station from the relay station 130 according to the handover request from the PHS terminal 110.

While the preferred embodiments of the present invention are explained above while referring to the diagrams, the present invention is not limited to these examples. It is clear that a person skilled in the art may make changes and modifications without departing from the scope of the appended claims and it is to be understood that such changes are within the technical scope of the present invention.

A PHS terminal was explained as a wireless communication terminal in the embodiments described above, however, the wireless communication terminal is not limited to a PHS terminal. For example, it is possible to form the present wireless communication system with high speed digital wireless communication (for example, WIMAX, next generation PHS etc) which uses an OFDM method or OFDMA method, and in this case, the wireless communication terminal or relays station can be provided with a communication function capable of the OFDM method or OFDMA method.

Furthermore, it is not necessary to perform each process in the wireless communication method of the present specification in time sequence according to the sequence described in the sequence diagrams. Processes performed in parallel or by sub routine may also be included.

### INDUSTRIAL APPLICABILITY OF THE INVENTION

The present invention can be used in a relay station which relays communication between a wireless communication terminal and a base station, and can also be used in a wireless communication system and a wireless communication method.

What is claimed is:

1. A relay station which can relay communication between a wireless communication terminal and a base station comprising:
a monitoring part which monitors communication quality between the wireless communication terminal and the relay station in the case where the relay station relays communication between the wireless communication terminal and the base station; and
a connection control part which controls the wireless communication terminal so that communication is performed between the wireless communication terminal and the base station without passing through the relay station according to an monitoring result.

2. The relay station being arranged in a movable body which can be boarded and alighted by a human, and further comprising a position estimation part which estimates a position of the wireless communication terminal according to an monitoring result of said monitoring part.

3. The relay station according to claim 2, wherein said position estimation part determines that the wireless communication terminal exists inside the movable body when a value which shows communication quality is more than a predetermined value and when the communication quality is stable within a predetermined variable range.

4. The relay station according to claim 2, wherein said connection control part selects a QoS with a high communication quality when the wireless communication terminal exists inside the movable body, and selects a QoS with high mobility when the wireless communication terminal exists outside the movable body.

5. The relay station according to claim 1, wherein said connection control part instructs the wireless communication terminal to refrain from handover when the wireless communication terminal exists inside the movable body, and instructs the wireless communication terminal to perform handover to a base station other than the relay station when the wireless communication terminal exists outside the movable body.

6. The relay station according to claim 5, wherein said connection control part instructs the wireless communication terminal to perform handover to a base station with which the relay station performs wireless communication when the wireless communication terminal exists outside of the movable body.

7. The relay station according to claim 1, further comprising:
a terminal function part which functions as a wireless communication terminal with respect to the base station; and
a base station function part which functions as a base station with respect to the wireless communication terminal.

8. The relay station according to claim 7, wherein said terminal function part performs wireless communication with the base station by a wireless communication method used between the base station and the wireless communication terminal.

9. A wireless communication system comprising:
a wireless communication terminal, a base station which performs wireless communication with said wireless communication terminal, and a relay station which relays communication between said wireless communication terminal and said base station;
wherein
said wireless communication terminal is provided with a terminal wireless communication part which establishes wireless communication with said base station or with said relay station, and a handover request part which requests a handover according to a handover reference from said relay station;
said relay station is provided with a monitoring part which monitors the quality of communication between said wireless communication terminal and said relay station in the case where communication is relayed between said wireless communication terminal and said base station, a position estimation part which estimates a position of said wireless communication terminal according to an monitoring result of said monitoring part, and a connection control part which switches a QoS of wireless communication with said wireless communication terminal according to the estimated position of said wireless communication terminal; and
said base station is provided with a base station wireless communication part which performs a handover between said relay station and said base station according to a handover request from said wireless communication terminal.

10. A wireless communication method for performing wireless communication using a wireless communication terminal, a base station which performs wireless communication with the wireless communication terminal, and a relay station which can relay communication between the wireless communication terminal and the base station;
wherein
the wireless communication terminal establishes wireless communication with the relay station,
the relay station monitors the communication quality of the wireless communication terminal and estimates a position of the wireless communication terminal,
the relay station switches a QoS of wireless communication with the wireless communication terminal according to the position of the wireless communication terminal, and switches a handover reference of the wireless communication terminal,
the wireless communication terminal performs a handover request to an indicated base station according to the handover reference from the relay station, and the base station performs the handover to a the base station from the relay station according to the handover request from the wireless communication terminal.
